(19) United States
(12) Patent Application Publication
(10) Pub. No.: US 2025/0030303 A1
(43) Pub. Date: Jan. 23, 2025

(54) HOUSING COMPONENT FOR AN ELECTRIC MOTOR AND ELECTRIC MOTOR

(71) Applicant: BorgWarner Inc., Auburn Hills, MI (US)

(72) Inventors: Silvio Koch, Kirchheimbolanden (DE); Denis Delannoy, Mainz (DE); Sebastian Vorläufer, Einhausen (DE); Benedikt Hummel, Zweibrücken (DE)

(21) Appl. No.: 18/763,653

(22) Filed: Jul. 3, 2024

(30) Foreign Application Priority Data
Jul. 21, 2023 (DE) DE102023119343.0

(51) Int. Cl. H02K 5/20; H02K 1/18; H02K 5/10

(52) U.S. Cl. CPC H02K 5/203; H02K 1/18; H02K 5/10

(57) ABSTRACT

A housing component for an electric motor is described, comprising a stator receptacle for a stator of the electric motor and an inner part which projects into the stator receptacle. The inner part forms a sleeve for receiving a shaft of the electric motor and an inner annular space, which is arranged between the stator receptacle and the sleeve. In addition, an electric motor with such a housing component is disclosed.

### CROSS REFERENCE TO RELATED APPLICATIONS

This application claims the priority to German Patent Application No. DE102023119343.0 filed on Jul. 21, 2023, and the entire content of this priority application is incorporated herein by reference in its entirety.

### TECHNICAL FIELD

The disclosure relates to a housing component for an electric motor as well as an electric motor. An electric motor comprising a housing component which has the features specified in the preamble of claim 1 is known, for example, from EP 3 091 637 B1.

### BACKGROUND

External rotor motors with an internally cooled stator, i.e. a cooling duct that runs through an interior surrounded by the stator, enable high performance in combination with a very compact design. A constant aim in the development of external rotor motors is to combine high performance with a compact design and high speeds.

An object of at least some implementations of the present disclosure is to show a way in which this goal can be achieved even better.

This object is solved by a housing component and by an electric motor. Advantageous further refinements of the disclosure are the subject of dependent claims.

### SUMMARY

A housing component for an electric motor may comprise, in addition to a stator holder for a stator of the electric motor and an inner part which projects into the stator holder, also a sleeve formed by the inner part for holding a shaft of the electric motor and also an inner annular space which is arranged between the stator holder and the sleeve. With such a housing part, the mounting of the shaft of the electric motor can be considerably improved compared to the mounting known from EP 3 091 637 B1.

A housing component is suitable for an electric motor comprising a stator with stator windings, a rotor with permanent magnets surrounding the stator, a shaft coupled to the rotor and mounted in a sleeve formed by the inner part of the housing component, and a cooling duct passing through an interior space surrounded by the stator.

The housing of the electric motor has as a first housing component a housing component, which forms a stator receptacle and thus a base, which lies opposite a first axial end of the stator. This first housing component forms the housing of the electric motor together with a second housing component, which lies opposite a second axial end of the stator as a cover. The first housing component has an inner part that protrudes into the stator. This inner part forms a sleeve, in which one end of the shaft and a bearing of the shaft are arranged, and an annular space, which is arranged between the stator and the sleeve and in which a cooling duct section for stator cooling can run. The housing component may have an inlet and an outlet for cooling liquid.

In this way, the space surrounded by the stator can be used both for cooling the stator and for cooling the bearing of the shaft. In addition, the bearing of the shaft can be improved by arranging several bearings at a greater distance than is the case with the electric motor known from EP 3 091 637 B1, for example.

An insert can be arranged in the annular space, which together with the inner part defines the cooling duct section. However, it is also possible that the function of such an insert is taken over by the first housing component, i.e. the first housing component defines the cooling duct section without separate, additional components in its inner part.

The sleeve formed by the inner part can be integrally provided with a sleeve base, i.e. the first housing component has both the sleeve and a sleeve base. In this case, the first housing component forms a pot in which one end of the shaft is arranged. Another possibility is that the sleeve base is a separate component that is attached to the first housing component. A further advantageous further refinement of the disclosure provides that the sleeve

has a tapered section. In this way, the housing component is adapted for a shaft which has different diameters and is mounted in the sleeve with two bearings, wherein a first bearing, which is arranged closer to the end of the shaft lying in the sleeve than a second bearing, has a smaller internal bearing diameter than the second bearing. In this way, the shaft with its bearings can be mounted in a simple manner by insertion into the sleeve formed by the housing component.

### BRIEF DESCRIPTION OF THE DRAWINGS

Further details and advantages of the disclosure are explained with reference to the accompanying drawings. Identical and corresponding components are provided with corresponding reference signs in the various drawings.

FIG. 1 shows a sectional view of an embodiment of an electric motor with a housing component;

FIG. 2 shows a view of the electric motor shown in FIG. 1;

FIG. 3 shows an example of the housing component of the electric motor shown in FIG. 1 with further parts defining a cooling duct; and

FIG. 4 shows another example of a housing component of an electric motor.

### DETAILED DESCRIPTION

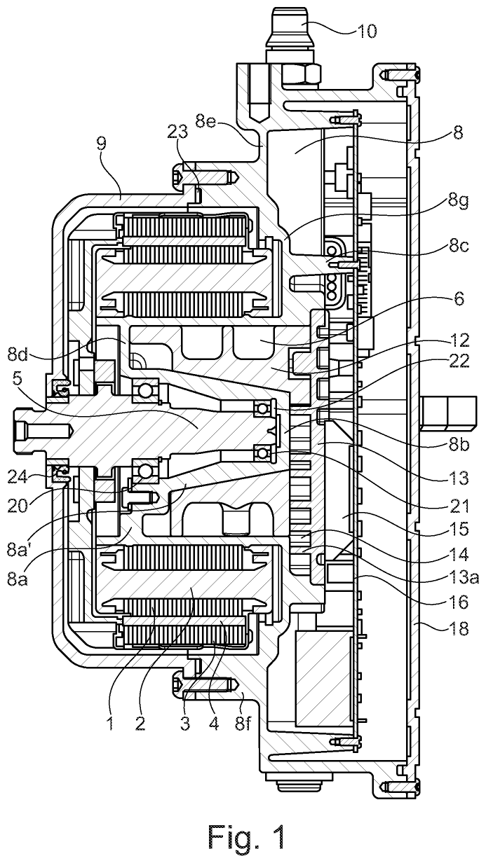

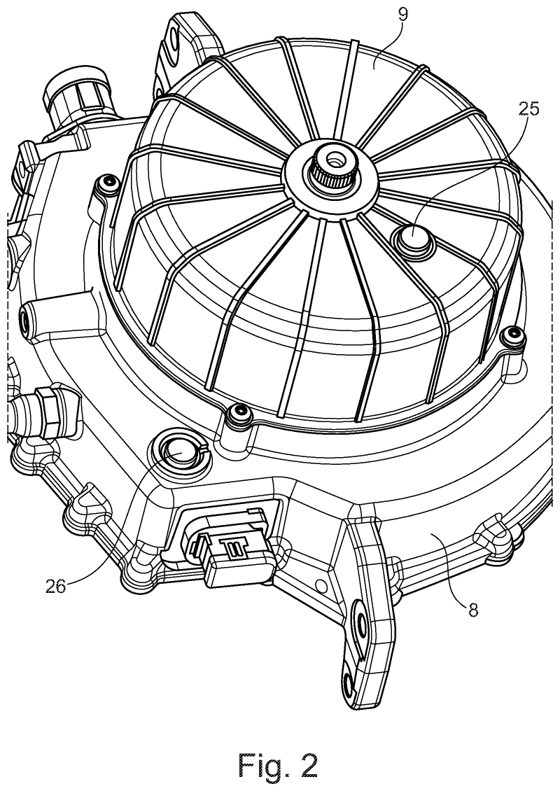

The electric motor shown in FIGS. 1 and 2 comprises a stator 1 with stator windings 2, a rotor 3 with permanent magnets 4 surrounding the stator 1, a shaft 5 connected to the rotor 3 in a rotationally fixed manner and a cooling duct 6, which leads through an interior space surrounded by the stator 1. Rotor 3 and stator 1 are arranged in a housing which has a first housing component 8 and a second housing component 9. A first end of the shaft 5 is arranged in the housing. A second end of the shaft 5 protrudes from the housing.

The first housing component 8 has a stator holder for the stator 1 of the electric motor and an inner part 8a, which projects into the stator holder. As FIG. 1 shows, the inner part 8a forms a sleeve for receiving the shaft 5 of the electric motor and an inner annular space, which is arranged between the stator receptacle and the sleeve and has an annular space base 8d. The annular space base 8d adjoins the outside of one end of the sleeve 8a and a sleeve base 8b is arranged at an opposite end of the sleeve 8a.

A section 6 of a cooling duct for cooling the stator 1 runs in this annular space. Two bearings 20, 21 of the shaft 5 are arranged in the sleeve 8a′ formed by the inner part 8a. The section of the cooling duct 6 running in the annular space thus cools the stator 1 on the one hand and the bearings 20, 21 on the other.

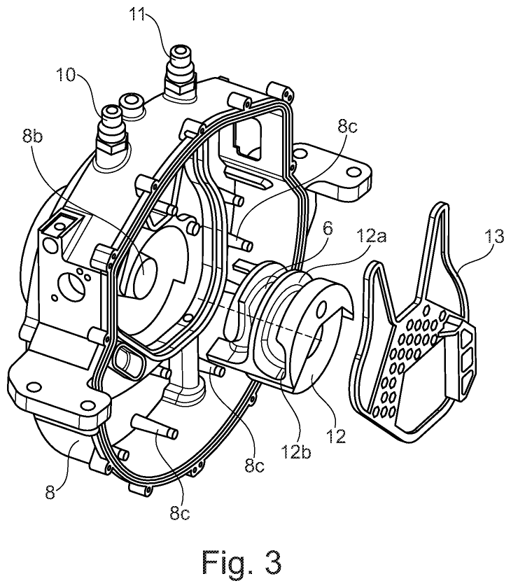

The first housing component 8 forms a base which is opposite a first axial end of the stator 1, while the second housing component 9 is a cover opposite a second axial end of the stator 1. The first housing component 8 is also shown in FIG. 3 and may have an inlet 10 and an outlet 11 for cooling liquid.

The first housing component 8 has an outer part 8e, which has an outer annular wall 8f with a larger circumference than the stator receptacle and forms an outer annular space, which is arranged between the stator receptacle and the outer annular wall 8f and is bounded by a housing base 8g.

The shaft 5 has different diameters. A first bearing 21, which is arranged closer to the end of the shaft 5 located in the housing than a second bearing 20, therefore has a smaller internal bearing diameter than the second bearing 20. In the embodiment example shown, the second bearing 20 is designed as a locating bearing. The second bearing 20 bears on the one hand against a stop formed by the first housing component 8, more specifically a stop formed by the housing inner part 8a, and on the other hand against a stop formed by the shaft 5. In the embodiment shown, the first bearing 21 is designed as a floating bearing which is resiliently pressed against a stop formed by the shaft 5, for example with a spring washer 22. The different diameters thus allow simple assembly, in which the bearings 20, 21 are pushed onto the shaft 5 and then the shaft 5 is pushed into the housing inner part 8a.

An insert 12 is arranged in the annular space of the inner part 8a of the first housing component 8, which together with the inner part 8a defines the cooling duct section 6 for cooling the stator 1. The insert 12 can have one rib 12a or several ribs 12a which extend in the circumferential direction, i.e. are oriented in the circumferential direction, and along which the cooling duct section 6 runs. Alternatively or additionally, the insert 12 can also have one or more ribs 12b, which extend in the axial direction in the annular space, i.e. are oriented in the axial direction, and along which the cooling duct section 6 runs.

The first housing component 8 carries a plate 13, which encloses the insert 12 in the annular space. The plate 13 can be welded to the first housing component 8 or attached to it in some other way, for example by soldering or screwing.

In the embodiment shown in FIG. 1, the plate 13 defines a further cooling duct section 14 between itself and the insert 12. This further cooling duct section 14 cools an electronic component 15, for example a transistor switch, of an electronic control unit that controls the power supply to the stator windings 2. In the embodiment shown, the further cooling duct section 14 is arranged upstream of the cooling duct section 6 for cooling the stator 1, but can also be arranged downstream of it.

The cooling duct section 6 for cooling the stator 1 is therefore arranged downstream of the further cooling duct section 14 for cooling the electronic component 15, but can also be arranged upstream of it. In this way, efficient cooling may be achieved. The first housing component 8 supports a circuit board 16 on which the control electronics are arranged. The electronic component 15 is arranged on a side of the printed circuit board 16 facing the plate 13 and rests against the plate 13. The plate 13 is therefore a cooling plate for one or more components of the control electronics.

The plate 13 can have protrusions 13a on its side facing away from the electronic component 15, which protrude into the further cooling duct section 14 and thus improve heat dissipation from the plate 13. The printed circuit board 16 is covered by a cover, for example a cover plate 18, and enclosed in a space delimited by the first housing component 8 and the cover.

The printed circuit board 16 can be attached to the first housing component 8 using screws. Other mechanical fastenings, such as adhesive bonding, are also possible. The first housing component 8 may have domes 8c on which the printed circuit board 16 sits.

The inner part 8a of the first housing component 8 can have a cylindrical outer surface. However, for production as a casting, it may be advantageous if the outer surface of the inner part 8a is conical in shape and defines a cone angle of less than 20°, for example less than 10°.

The housing can be designed as a sealed housing, for example in that a seal 23 is pressed between the first housing component 8 and the second housing component 9 and the shaft 5 is guided out of the second housing component 9 surrounded by a shaft seal 24. In order to prevent a dangerous increase in pressure in the interior containing the stator 1 and rotor 3 at increased operating temperatures, the housing has a pressure equalization opening 25, which is closed with a membrane that is permeable to air and impermeable to water. In the embodiment example shown in FIG. 2, this pressure equalization opening is arranged in the second housing component 9, but can also be arranged in the first housing component 8.

The circuit board 16 with the control electronics is arranged in an electronics compartment defined by the first housing component 8 and the cover plate 18, which is scaled to the outside and also to the interior containing the stator 1 and rotor 3. In order to prevent a dangerous increase in pressure in the electronics compartment at elevated operating temperatures, the first housing component 8 has a pressure equalization opening 26, which is sealed with a membrane that is permeable to air and impermeable to water.

In the embodiment example shown in FIG. 1, the inner part 8a of the first housing component 8 has the sleeve base 8b. The sleeve base 8b is therefore formed integrally with the inner part 8a and the first housing component 8. However, the sleeve base 8b can also be a separate component that is attached to the first housing component 8. For example, the plate 13 can form a base of the sleeve 8a′.

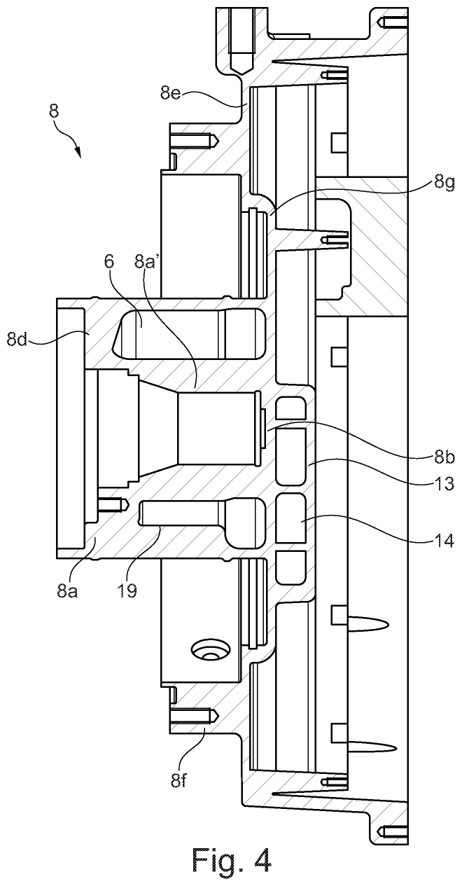

In FIG. 3, the first housing component 8 is shown together with two further components which together define the sections 6, 14 of the cooling duct for cooling the stator 1 and the electronic component 15, namely the first housing component 8, the insert 12 and the plate 13. However, these three components 8, 12, 13 can also be formed in one piece. FIG. 4 shows a corresponding embodiment example of the first housing component 8.

As in the embodiment of FIGS. 1 to 3, the first housing component 8 in FIG. 4 has an inner part 8a, which projects into the stator 1 and forms a sleeve 8a′ with a sleeve base 8b, in which one end of the shaft 5 is arranged. The inner part 8a of the first housing component 8 forms an annular space which is arranged between the stator 1 and the sleeve 8a′ and in which a cooling duct section 6 extends. The inner part 8a has a rib 19, which extends in the axial direction in the annular space and along which the cooling duct section 6 runs for cooling the stator 1.

In addition, the inner part 8a also forms the further cooling duct section 14 for cooling an electronic component 15 and has a plate 13 against which the electronic component 15 rests, as shown in FIG. 1.

In both embodiments of the first housing component 8, it has at least one cooling duct section, namely a section adjoining the inlet 10 or the outlet 11.

1. A housing component for an electric motor, comprising
a stator holder for a stator of the electric motor and
an inner part that projects into the stator holder,
wherein
the inner part forms a sleeve for receiving a shaft of the electric motor and an inner annular space which is arranged between the stator receptacle and the sleeve.

2. The housing component according to claim 1, wherein by a cooling duct section as well as an inlet and an outlet for cooling liquid.

3. The housing component according to claim 1, wherein the sleeve has a sleeve base.

4. The housing component according to claim 1, wherein the inner annular space has an annular space base, the annular space base is externally adjacent to one end of the sleeve.

5. The housing component according to claims 3, wherein the annular space base and the sleeve base are arranged at opposite ends of the sleeve.

6. The housing component according to claim 1, wherein an outer part which has an outer annular wall with a larger circumference than the stator receptacle and forms an outer annular space which is arranged between the stator receptacle and the outer annular wall and is bounded by a housing base.

7. The housing component according to claim 1, wherein the inner part has a cylindrical or a conical outer surface which defines a cone angle of less than 20°.

8. The housing component according to claim 1, wherein the inner part has a cylindrical or a conical outer surface which defines a cone angle of less than 10°.

9. The housing component according to claim 1, wherein the sleeve has a conical section.

10. The housing component according to claim 1, wherein a pressure equalization opening which is closed by a membrane that is permeable to air but impermeable to liquid water.

11. An electric motor, comprising
a first housing component according to one of the preceding claims, which together with a second housing component forms a housing,
a stator which has stator windings,
a rotor surrounding the stator, which has permanent magnets,
a shaft connected to the rotor so that it cannot rotate,
whereby the housing surrounds the rotor and the stator,
in which a first end of the shaft is arranged in the inner part of the first housing component and a second end of the shaft projects out of the housing, and
at least one bearing of the shaft is arranged in the sleeve formed by the first housing component.
